(19) United States
(12) Patent Application Publication
(10) Pub. No.: US 2013/0177673 A1
(43) Pub. Date: Jul. 11, 2013

(54) FLAVORFUL WATERLESS COFFEE AND PROCESS FOR MAKING

(71) Applicant: Pablito Arriola De La Rosa, San Diego, CA (US)

(72) Inventor: Pablito Arriola De La Rosa, San Diego, CA (US)

(21) Appl. No.: 13/544,885

(22) Filed: Jul. 9, 2012

Related U.S. Application Data
(63) Continuation-in-part of application No. 12/799,803, filed on May 3, 2010, now Pat. No. 8,236,366.

(51) Int. Cl. A23F 5/38

(52) U.S. Cl. CPC A23F 5/385
USPC 426/72; 426/655; 426/648; 426/285

(57) ABSTRACT

Traditionally, coffee would be prepared in one of the four basic recipes; black, with sugar, with cream, or with both sugar and cream to be enjoyed as a beverage drink. It is the object of this invention to bring coffee consumption to a new solid foundation so that one can have his/her coffee and eat it too in a delicious and chewy recipe that contains all the ingredients and flavorings that coffee drinkers love but without the hot water.

### CROSS REFERENCE TO RELATED APPLICATION(S)

This application is a continuation-in-part application which claims the benefit of priority under 35 U.S.C. §119(e) of U.S. Ser. No. 12/799,803 filed May 3, 2010 the entire content is incorporated herein by reference.

### BACKGROUND OF THE INVENTION

1. Field of the Invention

The invention relates generally to an edible instant cup of coffee substitute and more specifically to the product and methods for producing customizable edible instant coffee substitute that can be consumed at any time to provide the same effect as a typical morning coffee without the need to carry a cup and hot water.

2. Background Information

The present invention came about based on the Inventors driving experience a few times a month while putting kids through college, he was forced to routinely stop for coffee breaks to maintain alert and awake and/or restroom breaks required after ingesting large amounts of fluids. The toll of the fatigue and frequent breaks caused the inventor to think of a better as of staying awake, energized, and alert while driving without the frequent stops. The inventor developed a process tar making his favorite cup of copy in an edible form that could be unwrapped and chewed while driving the long distances.

Although, there are many coffee flavored candies and gums on the market none of these are true personalized coffee cup equivalents or derivatives as invented here. An example of a coffee flavored gum or candy, which may also include a chewy version, is presented in WO 95/00038; however, a gum or candy is not meant to deliver the ingredients of a cup of coffee to the user. Additionally, gums and or candies are typically over-sweetened, which is often a problem for those with diabetes or weight issues.

Thus, there is a need for a non-confectionary based product intended to serve as a substitute or a derivative for a cup of coffee that is a chewed and eaten product that comprises all of the ingredients in the cup of coffee without the hot water portion. Thus, the present invention is a product and process for a derivative or substitute cup of coffee in a non-spillable form without the need to heat water or carry a cup.

### SUMMARY OF THE INVENTION

It is the object of this invention to present a waterless version of the traditional instant coffee in a most versatile delicious format similar to a candy. The versatility of this invention will enable coffee lovers to enjoy their coffee anytime, anywhere; whether, jogging, walking, playing, working, driving a car, piloting an airplane, operating a heavy machinery, or floating inside a space station, without the danger of accidental scalding by hot water. Whenever one needs that instant caffeine boost for pep and energy, this long-felt needed invention will definitely come in handy. Furthermore, this waterless coffee can last up to a year or more.

However, keep in mind that this invention is not a coffee-flavored candy and it is not for kids. It contains caffeine and can be habit forming like regular caffeinated coffee.

The present invention is only similar or identical to coffee ingredients in a non-liquid form. Therefore, it is more concentrated and actually has a different flavor because the flavor is not diluted by water and an entire cup of coffee is reduced to a 10 gram chewable foodstuff about the size of a Vienna sausage link.

An embodiment of the present invention is a flavorful waterless coffee snack using three basic ingredients comprising of instant coffee granules, sweetener, and creamer which are mixed with a suitable flavor enhancing liquid solution comprising vanilla essence, or hazel nut essence for binding the dry ingredients to achieve a desired flavor and texture, wherein the texture is solid and in eating form rather than liquid in drinking form, and is suitable for manual shaping, molding, or extrusion into a size and shape that is eaten; and wherein each 10-gram piece of the chewy snack is the ingredient equivalent of a 6 oz. cup of conventionally brewed instant coffee without the hot water when using the formula: 1 tsp of instant coffee granules, 2 tsp of dry coffee creamer, and 2 grams of sweetener.

In additional embodiments the process for manufacturing the flavorful waterless coffee snack wherein the basic ingredients, comprise of instant coffee granules, creamer, and sweetener, and are coalesced with at least 7 wt, % of a liquid binding agent, based on the total weight of the dry ingredients. Additional embodiments include water as the binding agent for the dry ingredients. An additional contemplated embodiment of the present invention includes a process for manufacturing an embodied flavorful waterless coffee snack, wherein the product is heated up to 200 degrees Fahrenheit to aid the coalescence process during blending.

In additional embodiments, the stated proportional ratio of the ingredients may be made to a disclosed formula or to a preferred ratio to suit the maker's choice in caffeine content, flavor, and texture.

Further additional embodiments may include additional ingredients comprising either peanut, almond, pecan, cashew, walnut, macadamia, pine nut, sunflower seed, or in combination thereof whichever the maker finds appropriate as a supplement in taste and texture.

Yet further additional embodiments may include additional ingredients comprising vitamins and minerals that are already commonly used in the commercial food industry are added for nutritional supplements.

Yet still further embodiments may include ingredients comprising preservatives and product stabilizers that are already commonly used in the commercial food industry.

Another contemplated embodiment of the present invention includes an improved way of producing and consuming the ingredients in a cup of coffee wherein the improvement comprises: a) a means for producing the ingredient equivalent of a cup of coffee without the requirement of placing any of the ingredients in hot water, and without the need for a cup to drink from; b) wherein the improved product can not spill and/or scald a user; wherein said means for producing the equivalent of a cup of coffee without the hot water comprises mixing an individuals preferred coffee product along with any other preferred dry ingredients with enough of a binding agent to produce a chewy texture and consistency. Further embodiments of this process comprises a coalescence of three ingredients including instant coffee granules; a creamer and a sweetener.

Additional embodiments include the process include a dry ingredient creamer; a dry ingredient sweetener; and water as the binding agent. An alternative embodiment includes a product and process including a dry ingredient creamer and a liquid sweetener which serves as the binding agent. And an additional alternative embodiment includes a product and process comprising a dry ingredient sweetener and a liquid creamer that serves as the binding agent.

Yet an additional embodiment of the present invention include a product and process wherein the process includes mixing the dry ingredients with a suitable flavor enhancing liquid solution comprising vanilla essence, or hazel nut essence for binding the dry ingredients to achieve a desired flavor and texture, wherein the texture is solid and in eating form rather than liquid in drinking form, and is suitable for manual shaping, molding, or extrusion into a size and shape that is eaten. An additional embodiment includes the production of a product wherein each 10-gram piece of the chewy snack is the ingredient equivalent of a 6 oz. cup of conventionally brewed instant coffee without the hot water when using the formula: 1 tsp of instant coffee granules, 2 tsp of dry coffee creamer, and 2 grams of sweetener.

The present invention is not focused on the coffee flavor but on the ingredients ingested so that the user can get their morning coffee without hot water or a cup or worries of spilling. That is a “snack to take the place of the ingredients of a cup of coffee.”

### BRIEF DESCRIPTION OF THE DRAWINGS

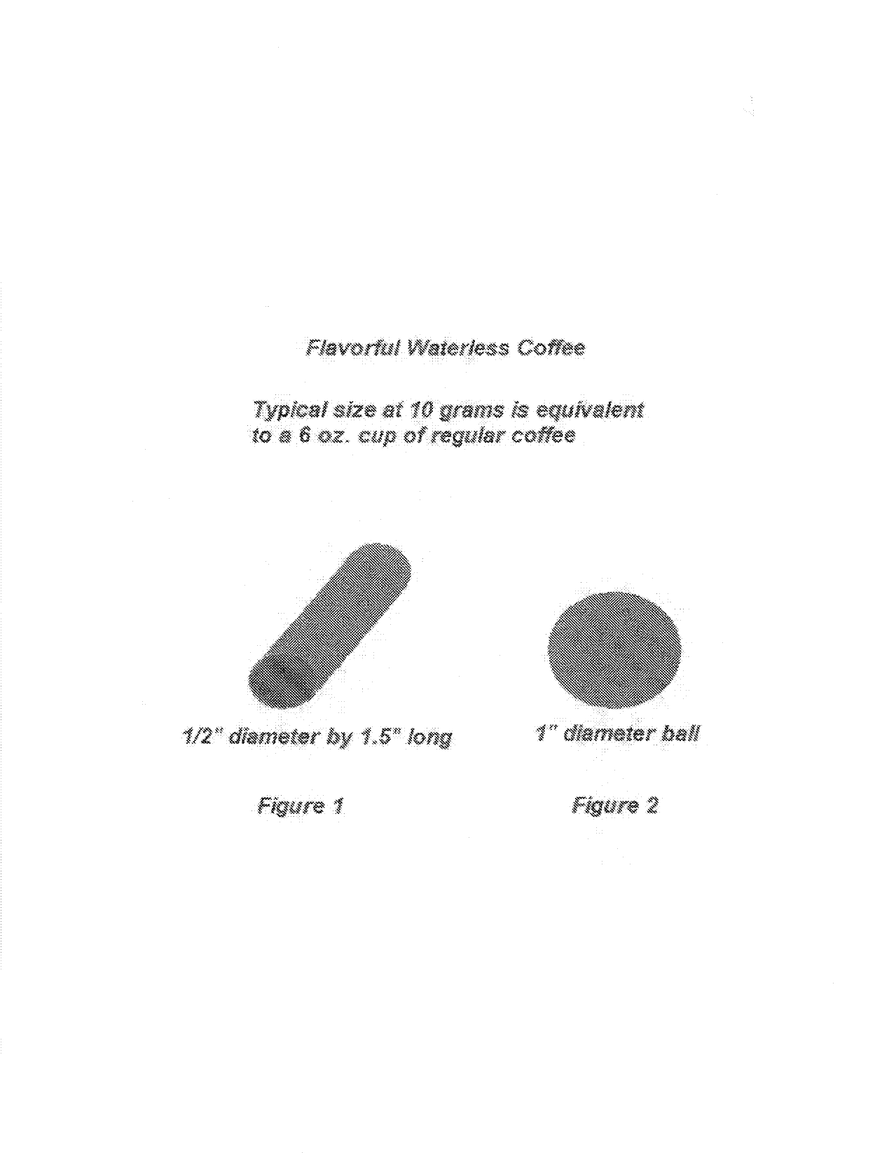

The present invention will be better understood by the following detailed description of some preferred embodiment of the invention, taken in conjunction with the accompanying drawings. FIG. 1 and FIG. 2 are perspective views of this flavorful waterless coffee according to the first embodiment of the invention. Only two drawings are presented because this invention will do well in any shape or form desired, limited only by the makers imagination. Each 10-gram piece of this waterless coffee is equivalent to a 6-ounce cup of traditionally prepared instant coffee.

### DETAILED DESCRIPTION OF THE INVENTION

Embodiments of the invention are to the process that covers a specific cup of instant coffee, in which the inventor excluded the hot water from their ordinarily prepared instant coffee,—thus producing a solid liquidless form rather than the usual drinkable instant coffee beverage. The amount of the solid ingredients may be variable because those variables depend on the makers preferred taste and do not affect the process of excluding the hot water.

For the purpose of the present invention the definition of “waterless coffee” means the exclusion of the water from a conventional Instant Coffee recipe and the process of fusing the disparate dry ingredients into a desired chewy texture that produce this new alternative coffee format. Although the binding process may include the use of a small amount of water to perform the fusing of the dry ingredients, it is considered waterless because it is not consumed in a liquid form.

Embodiments of the present invention are for a traditional instant coffee beverage transformed in to a chewable format . . . but still the coffee, because of its inherent caffeine content. It is not a candy, not a gum, not a confection. It is a waterless coffee recipe minus the hot water.

The process was discovered by accident when the inventor was preparing his usual morning instant coffee comprising of Nescafe Instant Coffee, Nestlé Coffee Creamer, and artificial sweetener Equal. The transformation from a coffee beverage drink to a chewy format was not easy because the dry ingredients must be mixed thoroughly while still dry. Then a proportional amount of water or liquid flavoring solution comprising vanilla, or hazelnut is added for binding the dry ingredients to a dough-like composition. The quantity of binding agent to be added depends on the desired texture and flavor of a finished product and therefore must be controlled by the maker during the mixing process. Small quantities of this invention can be made manually by rolling the mixed ingredients on a flat surface and then cut to the desired shape and size. For large quantities, a power mixer and extrusion machine is necessary.

Flavorful Waterless Coffee meets all of the above requirements and still qualifies as coffee because it contains all the three basic ingredients; creamer, sweetener, and instant coffee with its inherent caffeine content with no additives or preservatives. Only, the hot water is excluded.

In summary, conventional instant coffee is prepared where the dry ingredients are dissolved in hot water to produce a coffee beverage suitable for drinking. On the contrary, in the present invention, the ingredients are fused together using a liquid flavoring agent or water in a small amount for the sole purpose of binding the dry ingredients until a desired texture is achieved. The proportionality of the three basic ingredients may be variable because how one prepares his or her coffee is a personal choice.

Further embodiments of the present invention are to the improvement of an existing product into a new, better, and more versatile format through a process of which includes excluding the cumbersome hot water from the conventional recipe and then binding the conventional ingredients into an easy to handle and ingest chewable snack wherein no preservatives or additives are necessary.

Traditionally coffee is prepared in one of the four basic recipes; black, with sugar, with cream, or with both sugar and cream to be enjoyed as a beverage drink. It is the object of the present invention to bring coffee consumption to a new solid foundation so that one can have his/her coffee and eat it too in a delicious and chewy recipe that contains all the ingredients and flavorings that coffee drinkers love but without the hot water.

Embodiments of the present invention include the exclusion of the water from the conventional Instant Coffee recipe and the process of fusing the disparate dry ingredients into a desired chewy texture that produce this new alternative coffee format.

Embodiments of the present invention include excluding hot water from the traditional instant coffee recipe and coalescing the dry ingredients (coffee powder/granules, creamer, and sweetener) until a desired texture, similar to a “Tootsie Roll” is achieved. The proportionality the ingredients incorporated into the mix is variable because the embodiments are designed to allow for each individual's makers choice of how they like their coffee. That would be entirely up to the individual maker's choice.

Further embodiments include the process of coalescing the dry ingredients, which transforms a traditional instant liquid coffee drink into a chewy coffee alternative or derivative form of Flavorful Waterless Coffee.

An exemplary list of the three basic ingredients may include Nescafe Taster's Choice Instant coffee, Nestles Coffee Creamer, and Equal sweetener for sugar substitute.

Further embodiments of the present invention can use almost any liquid flavoring solution including but not limited to; milk, chocolate, fruit juice, soft drink, wine, liquor, or virtually any liquid solution fit for human consumption for flavoring/binding.

Yet further embodiments include an embodied coffee snack that can be produced in bigger pieces similar to a “Granola or Hershey bar” that can be equivalent to ten (10) cups or more of conventionally brewed coffee, depending on the relative proportion of each ingredients used.

The embodiments of the present invention can be produced in many ways by changing the relative proportion between the three basic ingredients thus changing the caffeine content and/or changing the flavor; hard or chewy, without adding additional ingredients to the basic composition of the commonly known brewed coffee. However, with this embodied snack, one can “have his/her coffee and eat it too”, anytime, anywhere, conveniently.

Accordingly, by varying the proportion of the three basic ingredients in the mix, an increase or decrease in caffeine amount can be achieved to equate to a larger or smaller cup of conventionally brewed coffee. Similarly, if a recipe is constant, an increase in the size of a product piece will also increase the caffeine equivalent accordingly.

The embodied product is a result of the transformation from conventionally drinking hot water flavored with coffee, sugar, and cream into enjoying the consumption of exactly the same three basic ingredients (coffee, sugar, and cream) in full strength without the hot water.

FIG. 1, and FIG. 2 are perspective illustration of a 10-gram piece of this invention that equates to a 6 oz. cup of coffee brewed traditionally when prepared using this formula: 1 tsp of instant coffee granules, 2 tsp of dry coffee creamer, 2 grams of dry artificial sweetener, and enough water or flavor enhancing liquid solution that will act as binding agent for the dry ingredients in order to achieve the desired texture and flavor.

The dry ingredients must be mixed thoroughly while still dry. Then a proportional amount of water or liquid flavoring solution comprising vanilla, or hazelnut is added for binding the dry ingredients to a dough-like composition. The quantity of binding agent to be added depends on the desired texture and flavor of the finished product and therefore must be controlled by the maker during the mixing process. Small quantities of this invention can be made manually by rolling the mixed ingredients on a flat surface and then cut to the desired shape and size. For large quantities, power mixer and extrusion machines are necessary.

Having discovered by accident the excellent coalescent properties of the basic three ingredients found in the ordinarily prepared instant coffee recipe, the inventor identified a process to speed up coalescence, the process, enhanced by the use of heat during mixing ingredients and with a proper amount of coalescing agent until the desired texture and consistency is achieved, resulting in the flavorful waterless coffee derivative or equivalent.

The product and process may include any of the additional properties or features:

1. By excluding the water from his morning cup of instant coffee, the inventor came up with a chewy waterless coffee.

2. The waterless coffee may be considered an instant coffee derivative.

3. The instant coffee derivative can be produced from liquid, to chewy, and up to a rock solid hardness as desired by controlling the amount of liquid binding agent used.

4. The instant coffee derivative can also be produced by evaporation using heat or by freeze-drying. (Similar to the method used in producing instant coffee granules.)

5. The instant coffee derivative is suitable to a wide spread application where coffee essence or flavoring is desired.

6. The instant coffee derivative when prepared in syrup, chewy, or solid form can be used in various food applications.

Although the invention has been described with reference to the above example, it will be understood that modifications and variations are encompassed within the spirit and scope of the invention. Accordingly, the invention is limited only by the following claims.

What is claimed is:

1. A flavorful waterless coffee snack using three basic ingredients comprising of instant coffee granules, sweetener, and creamer which are mixed with a suitable flavor enhancing liquid solution comprising vanilla essence, or hazel nut essence for binding the dry ingredients to achieve a desired flavor and texture, wherein the texture is solid and in eating form rather than liquid in drinking form, and is suitable for manual shaping, molding, or extrusion into a size and shape that is eaten; and wherein each 10-gram piece of the chewy snack is the ingredient equivalent of a 6 oz. cup of conventionally brewed instant coffee without the hot water when using the formula: 1 tsp of instant coffee granules, 2 tsp of dry coffee creamer, and 2 grams of sweetener.

2. The flavorful waterless coffee snack recited in claim 1, wherein the stated proportional ratio of the ingredients is variable to suit the maker's choice in caffeine content, flavor, and texture.

3. The flavorful waterless coffee snack recited in claim 1, further comprising any one or a combination of the ingredients selected from: peanut, almond, pecan, cashew, walnut, macadamia, pine nut, sunflower seed or other seeds and or nuts commonly consumed in energy or food bars.

4. The flavorful waterless coffee snack recited in claim 1 further comprising vitamin and/or mineral supplements.

5. The flavorful waterless coffee snack recited in claim 1, further comprising preservatives and/or product stabilizers.

6. The flavorful waterless coffee snack recited in claim 1, wherein water is the binding agent for the dry ingredients.

7. The process for manufacturing the flavorful waterless coffee snack recited in claim 1, wherein the basic ingredients comprising of instant coffee granules, creamer, and sweetener are coalesced with at least 7 wt, % of liquid binding agent, based on the total weight of the dry ingredients.

8. The process for manufacturing the flavorful waterless coffee snack recited in claim 7, wherein the product is heated up to 200 degrees Fahrenheit to aid the coalescence process during blending.

9. The process for manufacturing the flavorful waterless coffee snack recited in claim 1, wherein the basic ingredients comprising of instant coffee granules, creamer, and sweetener into a product of a chewy texture and consistency that is an ingredient equivalent of a cup of coffee without the hot water.

10. The flavorful waterless coffee product resulting from the process recited in claim 7.

11. An improved way of producing and consuming the ingredients in a cup of coffee wherein the improvement comprises:
a) a means for producing the ingredient equivalent of a cup of coffee without the requirement of placing any of the ingredients in hot water, and without the need for a cup to drink from;
b) wherein the improved product can not spill and/or scald a user;
c) Wherein said means for producing the equivalent of a cup of coffee without the hot water comprises mixing an individuals preferred coffee product along with any other preferred dry ingredients with enough of a binding agent to produce a chewy texture and consistency.

12. The improved product of claim 11, wherein the process comprises a coalescence of three ingredients including instant coffee granules; a creamer and a sweetener.

13. The improved product of claim 12, wherein the process comprises a dry ingredient creamer; a dry ingredient sweetener; and water as the binding agent.

14. The improved product of claim 12, wherein the process comprises a dry ingredient creamer and a liquid sweetener which serves as the binding agent.

15. The improved product of claim 12, wherein the process comprises a dry ingredient sweetener and a liquid creamer that serves as the binding agent.

16. The improved product of claim 12, wherein the process includes mixing the dry ingredients with a suitable flavor enhancing liquid solution comprising vanilla essence, or hazel nut essence for binding the dry ingredients to achieve a desired flavor and texture, wherein the texture is solid and in eating form rather than liquid in drinking form, and is suitable for manual shaping, molding, or extrusion into a size and shape that is eaten.

17. The process of claim 16, wherein each 10-gram piece of the chewy snack is the ingredient equivalent of a 6 oz. cup of conventionally brewed instant coffee without the hot water when using the formula: 1 tsp of instant coffee granules, 2 tsp of dry coffee creamer, and 2 grams of sweetener.
